(19) United States
(12) Patent Application Publication
(10) Pub. No.: US 2025/0128335 A1
(43) Pub. Date: Apr. 24, 2025

(54) CUTTING INSERT, CUTTING TOOL, AND METHOD FOR MANUFACTURING MACHINED PRODUCT

(71) Applicant: KYOCERA CORPORATION, Kyoto (JP)

(72) Inventor: Shin NAGAE, Kyoto (JP)

(21) Appl. No.: 18/704,925

(22) PCT Filed: Oct. 11, 2022
(86) PCT No.: PCT/JP2022/037808

§ 371 Date: Apr. 26, 2024

(30) Foreign Application Priority Data
Nov. 9, 2021 (JP) 2021-182742

(51) Int. Cl. B23B 27/14; B23B 27/22

(52) U.S. Cl. CPC B23B 27/145; B23B 27/22; B23B 2200/08

(57) ABSTRACT

A cutting insert includes an upper surface and a lower surface. The upper surface includes a first corner, a first side, a rake face, and a rising surface. The rising surface includes a first recessed portion recessed with respect to the first side, a first protruding portion located farther from the first corner than the first recessed portion, a second protruding portion located between the first protruding portion and the first side, and a first stepped portion located between the first protruding portion and the second protruding portion. The first protruding portion has a first front end portion located closest to the first side. A cross section orthogonal to the first side and including the first front end portion is a first cross section. At the first cross section, the second protruding portion is located closer to the lower surface than the first protruding portion.

### TECHNICAL FIELD

The present disclosure relates to a cutting insert used in machining for a workpiece, a cutting tool, and a method for manufacturing a machined product.

### BACKGROUND OF INVENTION

For example, a cutting insert described in Patent Document 1 is known as a cutting tool used in machining a workpiece such as one made of metal. In the cutting insert described in Patent Document 1, a recessed portion is formed in a direction along a main cutting edge at a peripheral surface (a rising surface, a breaker wall surface) of a protruding portion rising from a breaker groove. In semi-rough machining, a chip generated by the main cutting edge passes through the recessed portion without coming into contact with a bottom surface of the recessed portion, and a contact surface area between the chip and the peripheral surface is reduced. This reduces the area of the chip in contact with the peripheral surface in an advancing direction of the chip.

### CITATION LIST

### Patent Literature

Patent Document 1: JP 2015-447 A

### SUMMARY

In order to solve the above problem, according to one aspect of the present disclosure, provided is a cutting insert including an upper surface, a lower surface, a lateral surface located between the upper surface and the lower surface, and a cutting edge located at an intersection of the upper surface and the lateral surface. The upper surface includes a first corner, a first side extending from the first corner, a rake face located along the first corner and the first side and approaching the lower surface as it is away from the first corner and the first side, and a rising surface located along the rake face and getting away from the lower surface as it is away from the rake face. The rising surface includes a first recessed portion recessed with respect to the first side, a first protruding portion located farther from the first corner than the first recessed portion and protruding toward the first side, a second protruding portion located between the first protruding portion and the first side and protruding toward the first side, and a first stepped portion located between the first protruding portion and the second protruding portion. The first protruding portion includes a first front end portion located closest to the first side. A cross section orthogonal to the first side and including the first front end portion is a first cross section. At the first cross section, the second protruding portion is located closer to the lower surface than the first protruding portion.

### BRIEF DESCRIPTION OF THE DRAWINGS

FIG. 1 is a perspective view illustrating a cutting insert according to an embodiment.

FIG. 2 is a plan view of the cutting insert illustrated in FIG. 1 as viewed toward an upper surface.

FIG. 3 is an enlarged view of a region A1 illustrated in FIG. 1.

FIG. 4 is an enlarged view of a region A2 illustrated in FIG. 2.

FIG. 5 is an IV-A cross-sectional view of the cutting insert illustrated in FIG. 4.

FIG. 6 is an IV-B cross-sectional view of the cutting insert illustrated in FIG. 4.

FIG. 7 is an IV-C cross-sectional view of the cutting insert illustrated in FIG. 4.

FIG. 8 is an IV-D cross-sectional view of the cutting insert illustrated in FIG. 4.

FIG. 9 is an IV-E cross-sectional view of the cutting insert illustrated in FIG. 4.

FIG. 10 is an IX-A cross-sectional view of the cutting insert illustrated in FIG. 9.

FIG. 11 is an enlarged view of a region A3 illustrated in FIG. 10.

FIG. 12 is an IX-B cross-sectional view of the cutting insert illustrated in FIG. 9.

FIG. 13 is an enlarged view of a region A4 illustrated in FIG. 12.

FIG. 14 is an explanatory view illustrating deformed shapes of a first cross section of the cutting insert illustrated in FIG. 9 and a fourth cross section of a cutting insert of a variation.

FIG. 15 is an explanatory view schematically illustrating contact of a chip with a rising surface of the cutting insert illustrated in FIG. 1.

FIG. 16 is a perspective view illustrating a cutting tool according to an embodiment.

FIG. 17 is a schematic view illustrating a method for manufacturing a machined product of an embodiment.

### DESCRIPTION OF EMBODIMENTS

A detailed description will be given below of a cutting insert 1 according to an embodiment (hereinafter, simply referred to as “the insert 1”) with reference to the drawings. However, the respective drawings referenced below illustrate, in a simplified manner, only main members necessary for description of the embodiment. Thus, the insert 1 may include any constituent member not illustrated in each of the drawings referenced in the present disclosure. The dimensions of the members in the drawings do not faithfully represent the actual dimensions of the constituent members, the dimension ratios of the members, or the like.

By using a cutting tool including the insert 1 of the embodiment, machining can be performed. Examples of the cutting tool may include a turning tool and a rotating tool.

### Cutting Insert

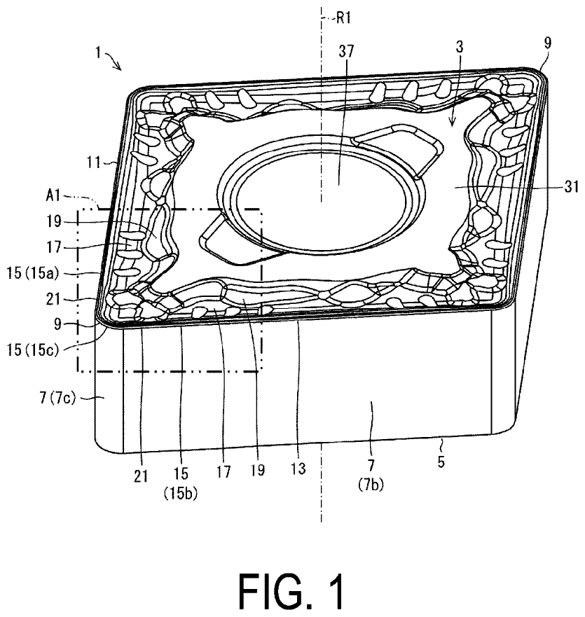

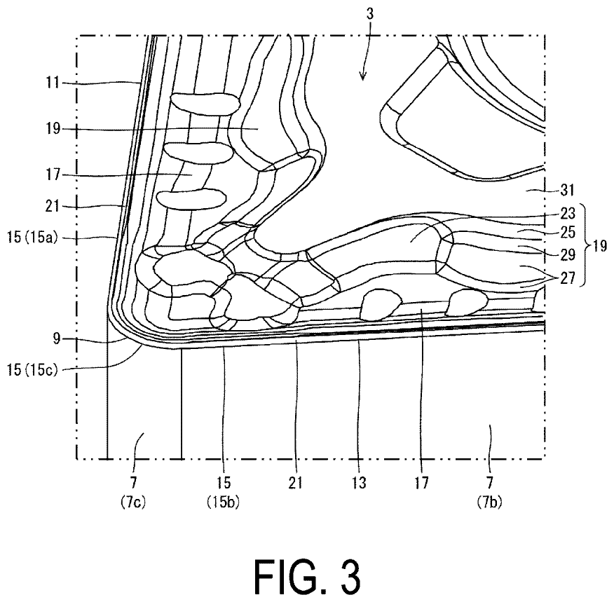

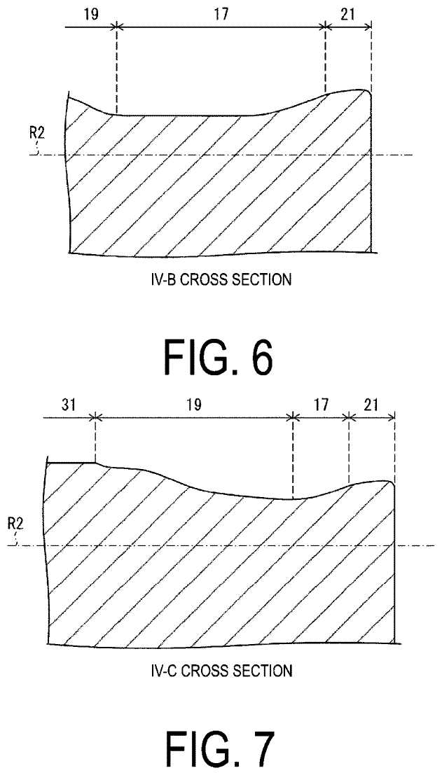

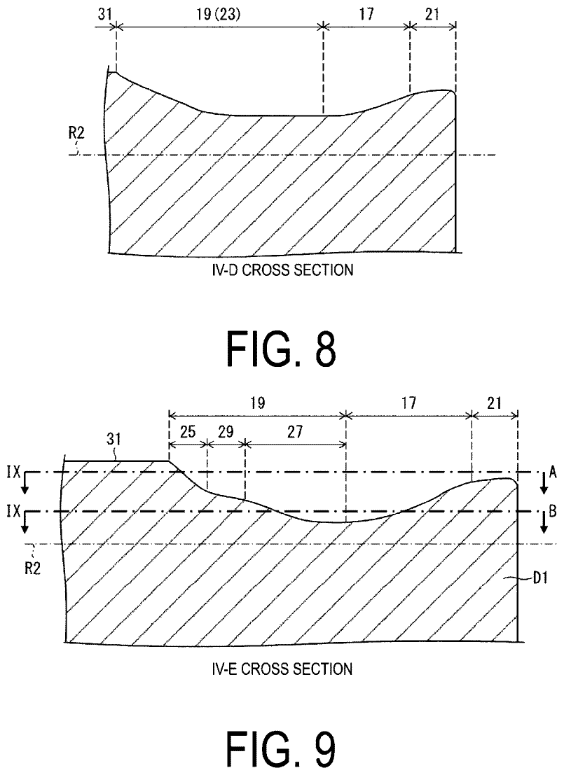

A configuration of the cutting insert 1 according to the present embodiment as an example will be described using FIGS. 1 to 15. As illustrated in FIG. 1, the insert 1 of the present embodiment includes an upper surface 3, a lower surface 5 located on an opposite side of the upper surface 3, and a lateral surface 7 located between the upper surface 3 and the lower surface 5.

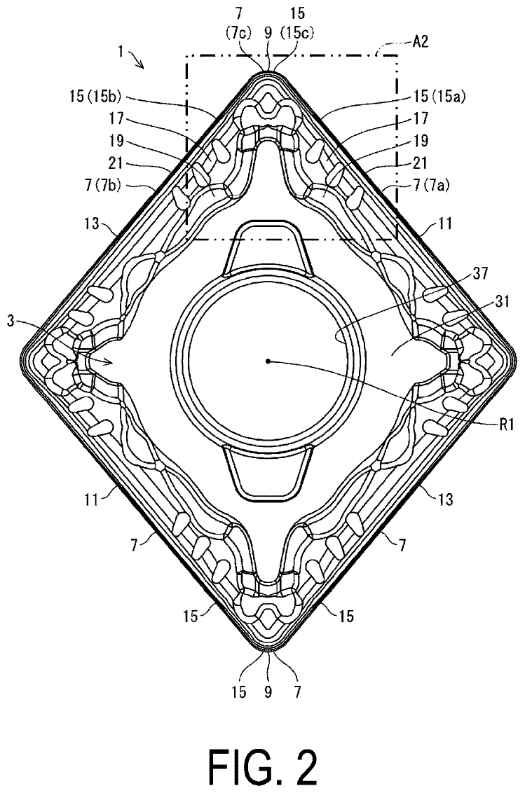

As illustrated in FIGS. 1 and 2, the upper surface 3 has a polygonal shape, and specifically, the upper surface 3 has a quadrangular shape. The lower surface 5 may have a polygonal shape as in the upper surface 3. The lower surface 5 may have the same size as the upper surface 3, or may be smaller than the upper surface 3. The lower surface 5 may be similar in shape to the upper surface 3 and may be slightly smaller than the upper surface 3. The insert 1 has a polygonal plate shape.

When a virtual straight line passing through a center of the upper surface 3 and a center of the lower surface 5 is defined as a central axis R1, the upper surface 3 may have a shape rotationally symmetric by 180° with respect to the central axis R1, as illustrated in FIG. 2. The shape of the insert 1 is not limited to the above configuration. The upper surface 3 may have, for example, a triangular shape or a hexagonal shape other than a quadrangular shape.

A virtual plane orthogonal to the central axis R1 and located between the upper surface 3 and the lower surface 5 is defined as a reference plane R2 (see FIGS. 5 to 9 and 14). The reference plane R2 can be used as a height reference for comparing heights of the respective portions constituting the upper surface 3. “Approaching the reference plane R2” can be rephrased as “approaching the lower surface 5”. “Away from the reference plane R2” can be rephrased as “away from the lower surface 5”. “Located near the reference plane R2” can be rephrased as “located near the lower surface 5”.

The upper surface 3 is quadrangular, so it has four corners. One of the four corners is referred to as a first corner 9. The upper surface 3 has the first corner 9 and a first side 11 and a second side 13 each extending from the first corner 9. The first corner 9 may be rephrased as being located between the first side 11 and the second side 13.

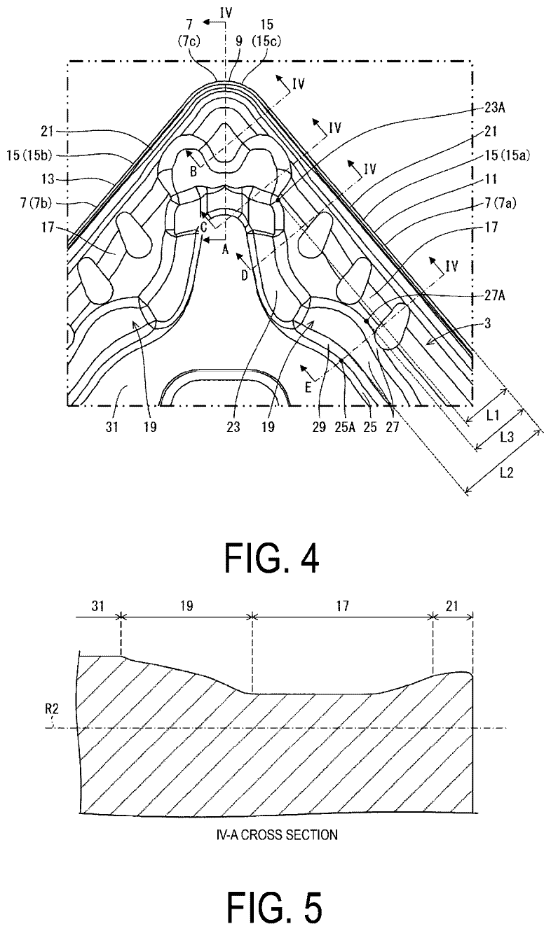

As illustrated in FIG. 4, the first corner 9 does not need to be sharp, and in the insert 1, the first corner 9 has an outwardly convex curved shape. When the upper surface 3 is viewed from the front, a radius of curvature of the first corner 9 having the convex curved shape may be constant or may vary. In the insert 1, the first corner 9 has an arc shape with a constant radius of curvature when the upper surface 3 is viewed from the front. Note that the radius of curvature of the first corner 9 having the convex curved shape is set to be smaller than the maximum width of the upper surface 3.

The first side 11 and the second side 13 of the upper surface 3 may have a substantially linear shape when visually confirmed, and do not need to be strictly linear. That is, the first side 11 and the second side 13 of the upper surface 3 may have, for example, a slightly curved convex shape or concave shape. Note that when the first side 11 and the second side 13 are curved, the radii of curvature of the first side 11 and the second side 13 are set to be greater than the maximum width of the upper surface 3.

The lateral surface 7 located between the upper surface 3 and the lower surface 5 may be connected to each of the upper surface 3 and the lower surface 5. In the insert 1, since the upper surface 3 has a polygonal shape, the lateral surface 7 has a plurality of surface regions connected to each side of the upper surface 3 and each of the first corners 9. In the insert 1, as the plurality of surface regions, the lateral surface 7 includes a first lateral surface 7a, a second lateral surface 7b, and a corner lateral surface 7c.

The first lateral surface 7a is located along the first side 11 of the upper surface 3. The second lateral surface 7b is located along the second side 13 of the upper surface 3. The corner lateral surface 7c is located along the first corner 9 of the upper surface 3. The corner lateral surface 7c is located between the first lateral surface 7a and the second lateral surface 7b, and is adjacent to each of the first lateral surface 7a and the second lateral surface 7b. The first lateral surface 7a and the second lateral surface 7b may have a planar shape. The corner lateral surface 7c may have a convex curved surface shape.

A cutting edge 15 may be located at at least a portion of a ridge line where the upper surface 3 and the lateral surface 7 intersect. In the insert 1, the cutting edge 15 is located, on the ridge line where the upper surface 3 and the lateral surface 7 intersect, at the first corner 9, a portion of the first side 11, and a portion of the second side 13. The cutting edge 15 may be located over the entirety of the first side 11 and the second side 13. Here, a portion of the cutting edge 15 located at the first corner 9 is conveniently referred to as a corner cutting edge 15c. A portion of the cutting edge 15 located at the first side 11 is conveniently referred to as a first cutting edge 15a. A portion of the cutting edge 15 located at the second side 13 is conveniently referred to as a second cutting edge 15b.

As illustrated in FIG. 4, in the insert 1, the upper surface 3 has a rake face 17 and a rising surface (blade wall surface) 19. As illustrated in FIG. 4, the rake face 17 is located along the first corner 9, the first side 11, and the second side 13. As illustrated in FIGS. 5 to 9, the rake face 17 approaches the reference plane R2 as it is away from the first corner 9, the first side 11, and the second side 13.

On the other hand, as illustrated in FIG. 4, the rising surface 19 is located along the rake face 17. As illustrated in FIGS. 5 to 9, the rising surface 19 gets away from the reference plane R2 as it is away from the rake face 17. A chip is curled by coming into contact with the rising surface 19, which facilitates discharge processing.

A boundary between the rake face 17 and the rising surface 19 is the lowest point. An inclined surface descending to the lowest point closest to the reference plane R2, in other words, an inclined surface approaching the reference plane R2 is a rake face, and an inclined surface ascending from the lowest point, in other words, an inclined surface away from the reference plane R2 is a rising surface. There may be a horizontal surface between the rake face 17 and the rising surface 19. That is, the lowest portion at the boundary between the rake face 17 and the rising surface 19 may be indicated by a line instead of a point in a cross-sectional view. In this case, the horizontal surface may function as a bottom surface.

As illustrated in FIG. 4, the upper surface 3 may have a land surface 21 extending toward the center of the upper surface 3 between the first side 11, second side 13, and first corner 9 and the rake face 17. In the insert 1, as illustrated in FIGS. 5 to 9, the land surface 21 is inclined so as to approach the reference plane R2 as it is away from the first corner 9, the first side 11, and the second side 13.

If an inclination angle is defined as an inclination with respect to the reference plane R2, when the land surface 21 is inclined, the inclination angle of the rake face 19 is greater than the inclination angle of the land surface 21. The land surface 21 may be a surface parallel to the reference plane R2, or may be inclined so as to be away from the reference plane R2 as it is away from the first corner 9, the first side 11, and the second side 13.

The upper surface 3 may further include an upper end surface 31 located along the rising surface 19.

### (Rising Surface)

Below, a description will be given of the rising surface 19. Here, as illustrated in FIG. 4, the rising surface 19 close to the first side 11, which contributes to discharge of chips generated by the first cutting edge 15a, will be described. Although not described, the same applies to the rising surface 19 close to the second side 13, which contributes to discharge of chips generated by the second cutting edge 15b.

As illustrated in FIG. 4, in the insert 1, the rising surface 19 has a first recessed portion 23, a first protruding portion 25, a second protruding portion 27, and a first stepped portion 29. The first recessed portion 23 is recessed with respect to the first side 11. The first protruding portion 25 is located farther from the first corner 9 than the first recessed portion 23 and protrudes toward the first side 11. The second protruding portion 27 is located between the first protruding portion 25 and the first side 11 and protrudes toward the first side 11. The first stepped portion 29 is located between the first protruding portion 25 and the second protruding portion 27.

The first protruding portion 25 has a first front end portion 25A located closest to the first side 11. In FIG. 4, the first front end portion 25A is highlighted by a black dot. A cross section orthogonal to the first side 11 and including the first front end portion 25A is a first cross section D1. FIG. 9 corresponds to the first cross section D1. As illustrated in FIG. 9, in the first cross section D1, the second protruding portion 27 is located closer to the reference plane R2 than the first protruding portion 25.

FIG. 14 is an explanatory view illustrating deformed shapes of a first cross section of the insert 1 illustrated in FIG. 9 and a fourth cross section of an insert of a variation. The first cross section D1′ is a deformed cross section of the first cross section D1. The fourth cross section of the insert of the variation will be described below.

As illustrated in FIG. 14, the chip generated by the first cutting edge 15a comes into contact with the second protruding portion 27 of the rising surface 19 via the land surface 21 and the rake face 17. Here, when the insert 1 is used for semi-rough machining and chips generated at the first cutting edge 15a are relatively thick, the chips come into contact with the first protruding portion 25 without coming into contact with the first stepped portion 29. For this reason, a contact surface area between the rising surface 19 and the chip in an advancing direction is reduced. This reduces, in the semi-rough machining, the contact of the chip with the rising surface 19 over a wide range in the advancing direction of the chip.

A thin chip generated when a feed rate is small also comes into contact with the first stepped portion 29. The thin chip comes into sliding contact with the second protruding portion 27, the first stepped portion 29, and the first protruding portion 25.

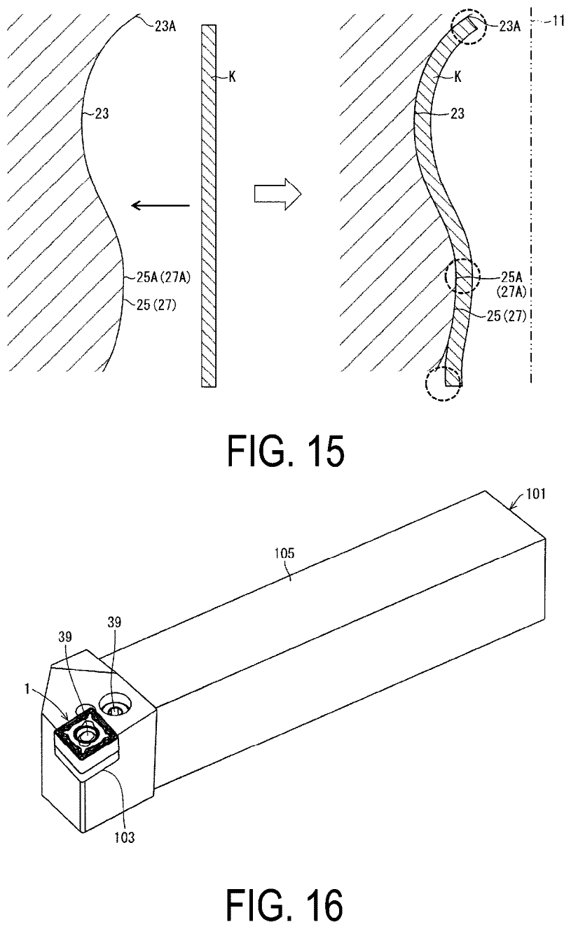

FIG. 15 is an explanatory view schematically illustrating the contact of the chip with the rising surface 19 of the insert 1 illustrated in FIG. 1. As illustrated in FIG. 15, the first protruding portion 25 and the second protruding portion 27 protrude toward the first side 11. For this reason, the chip K comes into contact with central portions of the first protruding portion 25 and the second protruding portion 27 and is unlikely to come into contact with both end portions of the first protruding portion 25 and the second protruding portion 27. In particular, when the chip K has a relatively large thickness generated in the semi-rough machining, the chip K is unlikely to come into contact with both end portions.

In this way, by providing the first protruding portion 25 and the second protruding portion 27 protruding toward the first side 11 on the rising surface 19, the contact surface area between the chip and the rising surface 19 is reduced also in a width direction of the chip. This can reduce the contact of the chip with the rising surface 19 in a wide range in the width direction of the chip.

As illustrated in FIG. 4, in the insert 1, the first recessed portion 23 is formed on a side closer to the first corner 9 than the first protruding portion 25. For this reason, as illustrated in FIG. 15, one end portion in the width direction of the chip K in contact with the first protruding portion 25 and the chip K in contact with the second protruding portion 27 comes into contact with the first recessed portion 23. Thereby, the behavior of the chip can be more stabilized than in a configuration in which only an inner side of the chip in the width direction is in contact with the first protruding portion 25 or the second protruding portion 27.

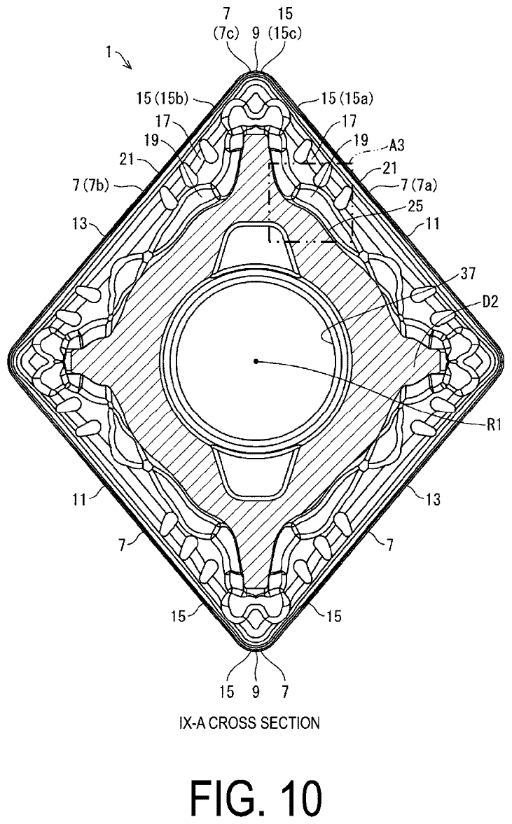

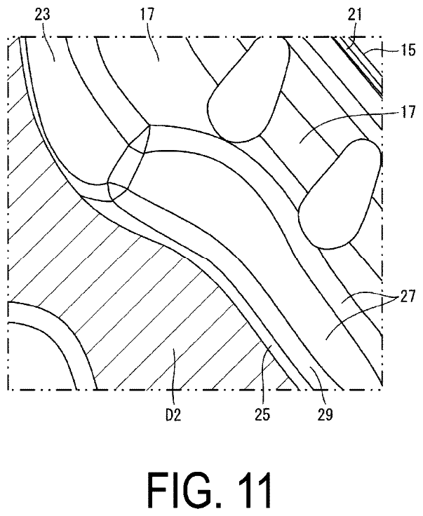

As illustrated in FIGS. 10 and 11, the first protruding portion 25 may have a curved shape in a second cross section D2. As illustrated in FIG. 9, the second cross section D2 is a cross section parallel to the upper end surface 31 and including the first protruding portion 25 in the insert 1, and is an IX-A cross-sectional view in the insert 1 illustrated in FIG. 9.

When the shape of the first protruding portion 25 in the second cross section D2 is a polygonal shape, wear is more likely to progress at the corners, but the curved shape can reduce the progress of wear of the first protruding portion 25.

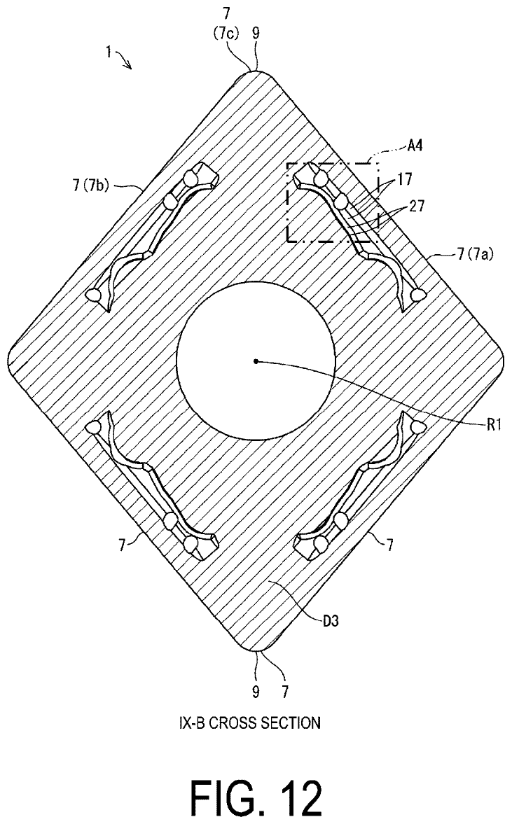

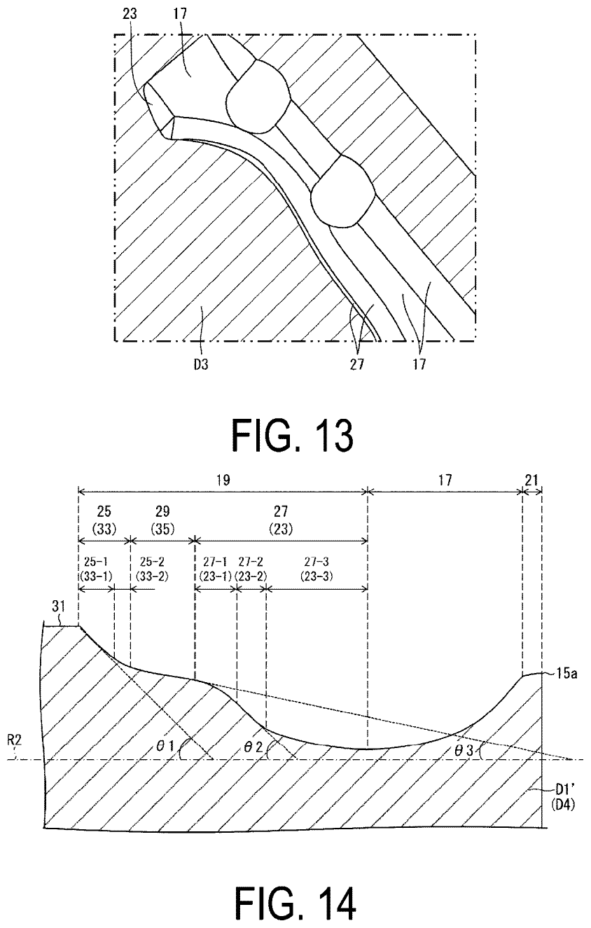

As illustrated in FIGS. 12 and 13, the second protruding portion 27 may have a curved shape in a third cross section D3. As illustrated in FIG. 9, the third cross section D3 is a cross section parallel to the upper end surface 31 and including the second protruding portion 27 in the insert 1, and is an IX-B cross-sectional view in the insert 1 illustrated in FIG. 9. Also in this case, the curved shape can reduce the progress of wear of the second protruding portion 27.

In the insert 1, as illustrated in FIG. 4, the first recessed portion 23 may have an end portion 23A closest to the first corner 9, and the end portion 23A may be located closer to the first side 11 than the first front end portion 25A. That is, as illustrated in FIG. 4, when a distance from the first side 11 to the end portion 23A is defined as L1 and a distance from the first side 11 to the first front end portion 25A is defined as L2, L1 is set to be smaller than L2 (L1<L2). In FIG. 4, the end portion 23A is highlighted by a black dot.

As illustrated in FIG. 15, since the end portion 23A is closer to the first side 11 than the first front end portion 25A, the chip K first comes into contact with the end portion 23A earlier than the first front end portion 25A, and the behavior of the chip K can be controlled at the end portion 23A. The corner cutting edge 15c located at the first corner 9 is more easily chipped and delicate than the first cutting edge 15a. For this reason, the chip clogging at the corner cutting edge 15c directly leads to damage of the corner cutting edge 15c. According to the above configuration, the behavior of the chip near the corner cutting edge 15c can be stably controlled, and the corner cutting edge 15c is less likely to be damaged.

The second protruding portion 27 may have a second front end portion 27A located closest to the first side 11, and the end portion 23A may be located closer to the first side 11 than the second front end portion 27A. That is, as illustrated in FIG. 4, when the distance from the first side 11 to the end portion 23A is defined as L1 and a distance from the first side 11 to the second front end portion 27A is defined as L3, L1 is set to be smaller than L3 (L1<L3). In FIG. 4, the second front end portion 27A is highlighted by a black dot.

Also in this case, as illustrated in FIG. 15, when the end portion 23A is closer to the first side 11 than the second front end portion 27A, the behavior of the chip K can be controlled at the end portion 23A, and the corner cutting edge 15c is less likely to be damaged.

In the insert 1, as illustrated in FIG. 14, in the first cross section D1′, the first protruding portion 25 may include a first linear portion 25-1, and the second protruding portion 27 may include a second linear portion 27-2. This configuration makes it easier to ensure a function of guiding the chip by the first protruding portion 25 and the second protruding portion 27 while reducing the contact surface area between the chip and the rising surface 19.

In an example illustrated in FIG. 14, the first protruding portion 25 has a first linear portion 25-1 located along the upper end surface 31 and a first concave curved portion 25-2 located along the first stepped portion 29. The first linear portion 25-1 may be a convex curve.

The second protruding portion 27 includes a first convex curved portion 27-1, a second concave curved portion 27-3, and a second linear portion 27-2. The first convex curved portion 27-1 is located along the first stepped portion 29. The second concave curved portion 27-3 is located along the rake face 17. The second linear portion 27-2 is located between the first convex curved portion 27-1 and the second concave curved portion 27-3.

The first stepped portion 29 is a concave-convex curve with an inflection point. A position closer to the second protruding portion 27 is a convex curve, and a position closer to the first protruding portion 25 is a concave curve. The first stepped portion 29 may be linear. The first stepped portion 29 may be parallel to the reference plane R2. A boundary between the first stepped portion 29 and the first concave curved portion 25-2 may be a curve or may have an angle. A boundary between the first stepped portion 29 and the first convex curved portion 27-1 may also be a curve or have an angle.

In the insert 1, as illustrated in FIG. 14, in the first cross section D1′, an inclination angle θ1 of the first linear portion 25-1 may be greater than an inclination angle θ2 of the second linear portion 27-2, and the first linear portion 25-1 may be shorter than the second linear portion 27-2.

According to the above-described configuration, the first linear portion 25-1 having a greater inclination angle and a higher braking effect than the second linear portion 27-2 is set to be shorter. As a result, the function of guiding the chips by the first protruding portion 25 and the second protruding portion 27 can be secured, and the chip discharge performance can be improved.

An inclination angle θ3 of the first stepped portion 29 is smaller than the inclination angle θ1 of the first linear portion 25-1 and the inclination angle θ2 of the second linear portion 27-2. The inclination angle θ1 is, for example, 30° to 60°, the inclination angle θ2 is, for example, 30° to 60°, and the inclination angle θ3 is, for example, 10° to 25°.

In the insert 1, as illustrated in FIG. 14, the rising surface 19 may have a second recessed portion 33 located between the first recessed portion 23 and the upper end surface 31 and a second stepped portion 35 located between the first recessed portion 23 and the second recessed portion 33.

With such a configuration, even between the first recessed portion 23 and the second recessed portion 33, relatively thick chips generated at the first cutting edge 15a during semi-rough machining come into contact with the second recessed portion 33 without coming into contact with the second stepped portion 35. For this reason, a contact surface area between the rising surface 19 and the chip in an advancing direction is reduced. This reduces, in the semi-rough machining, the contact of the chip with the rising surface 19 over a wide range in the advancing direction of the chip.

A thin chip generated when a feed rate is small also comes into contact with the second stepped portion 35, and comes into sliding contact with the first recessed portion 23, the second stepped portion 35, and the second recessed portion 33.

In this case, as illustrated in FIG. 14, in a fourth cross section D4, the first recessed portion 23 may include a third linear portion 23-2, and the second recessed portion 33 may include a fourth linear portion 33-1. The fourth cross section D4 is a cross section orthogonal to the first side 11 and intersecting the first recessed portion 23 and the second recessed portion 33. This configuration makes it easier to ensure a function of guiding the chip by the first recessed portion 23 and the second recessed portion 33 while reducing the contact surface area between the chip and the rising surface 19.

In the example illustrated in FIG. 14, the first recessed portion 23 includes a second convex curved portion 23-1, a third concave curved portion 23-3, and a third linear portion 23-2. The second convex curved portion 23-1 is located along the second stepped portion 35. The third concave curved portion 23-3 is located along the rake face 17. The third linear portion 23-2 is located between the second convex curved portion 23-1 and the third concave curved portion 23-3.

The second recessed portion 33 includes a fourth linear portion 33-1 located along the upper end surface 31 and a fourth concave curved portion 33-2 located along the second stepped portion 35.

The second stepped portion 35 is a concave-convex curve with an inflection point. A position closer to the first recessed portion 23 is a convex curve, and a position closer to the second recessed portion 33 is a concave curve. The second stepped portion 35 may be linear. The second stepped portion 35 may be parallel to the reference plane R2. A boundary between the second stepped portion 35 and the fourth concave curved portion 33-2 may be a curve or may have an angle. A boundary between the second stepped portion 35 and the second convex curved portion 23-1 may also be a curve or have an angle.

In this case, in the fourth cross section D4, the inclination angle θ1 of the fourth linear portion 33-1 may be greater than the inclination angle θ2 of the third linear portion 23-2, and the fourth linear portion 33-1 may be shorter than the third linear portion 23-2.

According to the above configuration, the fourth linear portion 33-1 having a greater inclination angle and a higher braking effect than the third linear portion 23-2 is set to be shorter. As a result, the function of guiding the chip by the first recessed portion 23 and the second recessed portion 33 can be ensured, and the chip discharge performance can be improved.

### Other Configuration

The insert 1 includes a through-hole 37 opening at the upper surface 3 and the lower surface 5. The through-hole 37 may be formed from the center of the upper surface 3 toward the center of the lower surface 5. The through-hole 37 may be open at each of surface regions opposite to each other at the lateral surface 7. The through-hole 37 can be used to secure the insert 1 to a holder of a cutting tool. For example, the insert 1 can be fixed to the holder by inserting a screw into the through-hole 37 and screwing the insert 1.

The direction in which the through-hole 37 extends, in other words, the penetrating direction may be orthogonal to the upper surface 3 and the lower surface 5 as illustrated in the example of FIG. 1. A central axis of the through-hole 37 matches the central axis R1 because the through-hole 37 is formed from the center of the upper surface 3 toward the center of the lower surface 5.

A size of the insert 1 is not particularly limited. The maximum width of the upper surface 3 may be set to about 6 mm to 25 mm, for example. A height from the upper surface 3 to the lower surface 5 may be set to about 1 mm to 10 mm. Here, the height from the upper surface 3 to the lower surface 5 refers to a length in a direction parallel to the central axis R1 between an upper end of the upper surface 3, i.e., the upper end surface 31 and a lower end of the lower surface 5.

Examples of a material of the insert 1 may include cemented carbide alloy, and cermet. The composition of the cemented carbide alloy includes WC—Co, WC—TiC—Co, and WC—TiC—TaC—Co, for example. Here, WC, TiC, and TaC are hard particles, and Co is a binder phase.

Cermet is a sintered composite material in which a metal is combined with a ceramic component. Specifically, examples of the cermet include titanium compounds in which one of titanium carbide (TiC) and titanium nitride (TiN) is the main component. However, note that the material of the insert 1 is not limited to the composition described above.

The surface of the insert 1 may be coated with a coating film using a chemical vapor deposition (CVD) method or a physical vapor deposition (PVD) method. Examples of the composition of the coating film include titanium carbide (TiC), titanium nitride (TiN), titanium carbonitride (TiCN), and alumina (Al₂O₃).

### Cutting Tool

A cutting tool 101 according to an embodiment will be described with reference to the drawings. The cutting tool 101 of an example illustrated in FIG. 16 has a rod shape extending from a first end toward a second end and includes a holder 105 including a pocket 103 located on the first end side and the above-described insert 1 located in the pocket 103. In the cutting tool 101 of the present disclosure, the insert 1 is mounted such that a portion that is used as a cutting edge protrudes from the first end of the holder 105. Usually, the first end is referred to as a “tip end,” and the second end is referred to as a “rear end.”

The holder 105 has an elongated rod shape. The first end side of the holder 105 is provided with one pocket 103. The pocket 103 is a portion in which the insert 1 is mounted, and is opened to an end surface located on the first end side of the holder 105. At this time, the pocket 103 is opened to a side surface of the holder 105, making it possible to easily mount the insert 1. Specifically, the pocket 103 includes a seating face and a binding side face. The seating face is parallel to a bottom surface of the holder 105. The binding side face inclines with respect to the seating face.

The insert 1 is located in the pocket 103. In this case, the lower surface 5 of the insert 1 may be in direct contact with the pocket 103, and a sheet may be sandwiched between the insert 1 and the pocket 103.

The insert 1 is mounted such that a portion used as a cutting edge protrudes outward from the holder 105. In the present disclosure, the insert 1 is mounted on the holder 105 using a clamp member (lever lock) 39. A member for mounting the insert 1 to the holder 105 is not limited to the clamp member 39, and for example, a fixing screw may be used. That is, the insert 1 may be mounted on the holder 105 by inserting a fixing screw into the through-hole 37 of the insert 1, inserting a tip end of the fixing screw into a screw hole (not illustrated) formed at the pocket 103, and screwing threaded portions thereof together.

As the holder 105, steel, cast iron, or the like can be used. In particular, steel with high toughness may be used among these members.

In the present disclosure, a cutting tool used in so-called turning processing is exemplified. Examples of the turning processing may include inner diameter processing, outer diameter processing, and grooving processing. The cutting tool is not limited to a cutting tool used in turning processing. For example, the insert 1 according to the above-described embodiment may be used as a cutting tool used in milling processing.

### Method for Manufacturing Machined Product

Description will be given of a method for manufacturing a machined product according to an embodiment. A machined product is manufactured by machining a workpiece 201. The method for manufacturing a machined product according to the present disclosure includes the following steps. That is, the present embodiment includes:
(1) Rotating the workpiece 201,
(2) Bringing the cutting tool 101 represented in the embodiment described above into contact with the workpiece 201 that is rotating, and
(3) Separating the cutting tool 101 from the workpiece 201.

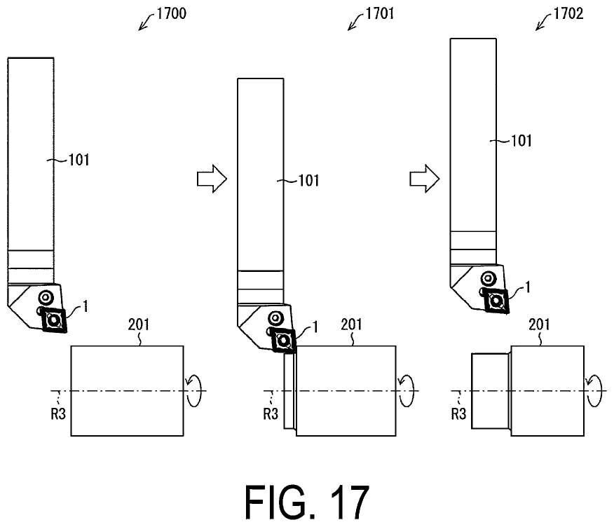

More specifically, first, as illustrated in a view of the reference numeral 1700 in FIG. 17, the workpiece 201 is rotated about an axis R3, and the cutting tool 101 is relatively brought close to the workpiece 201. As illustrated in a view of the reference numeral 1701 in FIG. 17, the cutting edge of the cutting tool 101 is brought into contact with the workpiece 201 and cuts the workpiece 201. As illustrated in a view of the reference numeral 1702 in FIG. 17, the cutting tool 101 is relatively moved away from the workpiece 201.

In the present disclosure, the cutting tool 101 is brought close to the workpiece 201 by moving the cutting tool 101 in a state in which the axis R3 is fixed and the workpiece 201 is rotated around the axis R3. In the view of the reference numeral 1701 in FIG. 17, the workpiece 201 is cut by bringing the cutting edge of the insert 1 into contact with the workpiece 201 that is rotating. In the view of the reference numeral 1702 in FIG. 17, the cutting tool 101 is moved while the workpiece 201 is rotated, and accordingly the cutting tool 101 is moved away from the workpiece 201.

In the machining in the method for manufacturing according to the present disclosure, the cutting tool 101 is brought into contact with the workpiece 201 or the cutting tool 101 is moved away from the workpiece 201, by moving the cutting tool 101 in each step. However, naturally, the present disclosure is not limited to such a configuration.

For example, in step (1), the workpiece 201 may be brought close to the cutting tool 101. In step (3), the workpiece 201 may be moved away from the cutting tool 101. When the machining is to be continued, steps of bringing the cutting edge of the insert into contact with different places on the workpiece 201 may be repeated while maintaining the rotating state of the workpiece 201.

Representative examples of a material of the workpiece 201 may include carbon steel, alloy steel, stainless steel, cast iron, and non-ferrous metal.

In the present disclosure, the invention has been described above based on the various drawings and examples. However, the invention according to the present disclosure is not limited to each embodiment described above. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure.

Note that these variations or modifications are included within the scope of the present disclosure.

### REFERENCE SIGNS

1 Cutting insert
3 Upper surface
5 Lower surface
7 Lateral surface
15 Cutting edge
17 Rake face
19 Rising surface
23 First recessed portion
23-2 Third linear portion
23A End portion
25 First protruding portion
25-1 First linear portion
25A First front end portion
27 Second protruding portion
27-2 Second linear portion
27A Second front end portion
29 First stepped portion
31 Upper end surface
33 Second recessed portion
33-1 Fourth linear portion
35 Second stepped portion
37 Through-hole
39 Clamp member
101 Cutting tool
103 Pocket
105 Holder
201 Workpiece
D1 First cross section
D2 Second cross section
D3 Third cross section
D4 Fourth cross section
θ1 Inclination angle
θ2 Inclination angle

1. A cutting insert comprising:
an upper surface;
a lower surface;
a lateral surface located between the upper surface and the lower surface; and
a cutting edge located at an intersection of the upper surface and the lateral surface,
wherein the upper surface comprises:
a first corner;
a first side extending from the first corner;
a rake face located along the first corner and the first side and approaching the lower surface as the rake face is away from the first corner and the first side; and
a rising surface located along the rake face and getting away from the lower surface as the rising surface is away from the rake face,
the rising surface comprises:
a first recessed portion recessed with respect to the first side;
a first protruding portion located farther from the first corner than the first recessed portion and protruding toward the first side;
a second protruding portion located between the first protruding portion and the first side and protruding toward the first side; and
a first stepped portion located between the first protruding portion and the second protruding portion,
the first protruding portion comprises a first front end portion located closest to the first side,
a cross section orthogonal to the first side and including the first front end portion is a first cross section, and
at the first cross section, the second protruding portion is located closer to the lower surface than the first protruding portion.

2. The cutting insert according to claim 1, wherein
the upper surface further comprises an upper end surface located along the rising surface,
a cross section parallel to the upper end surface and intersecting the first protruding portion is a second cross section, and
at the second cross section, the first protruding portion has a curved shape.

3. The cutting insert according to claim 1, wherein
the upper surface further comprises an upper end surface located along the rising surface,
a cross section parallel to the upper end surface and intersecting the second protruding portion is a third cross section, and
at the third cross-section, the second protruding portion has a curved shape.

4. The cutting insert according to claim 1, wherein
the first recessed portion comprises an end portion closest to the first corner, and
the end portion is located closer to the first side than the first front end portion.

5. The cutting insert according to claim 4, wherein
the second protruding portion comprises a second front end portion located closest to the first side, and
the end portion is located closer to the first side than the second front end portion.

6. The cutting insert according to claim 1, wherein
at the first cross section,
the first protruding portion comprises a first linear portion, and
the second protruding portion comprises a second linear portion.

7. The cutting insert according to claim 6, wherein
at the first cross section,
an inclination angle of the first linear portion is greater than an inclination angle of the second linear portion, and
the first linear portion is shorter than the second linear portion.

8. The cutting insert according to claim 1, wherein
the upper surface further comprises an upper end surface located along the rising surface, and
the rising surface comprises:
a second recessed portion located between the first recessed portion and the upper end surface, and
a second stepped portion located between the first recessed portion and the second recessed portion.

9. The cutting insert according to claim 8, wherein
a cross section orthogonal to the first side and intersecting the first recessed portion and the second recessed portion is a fourth cross section, and
at the fourth cross section,
the first recessed portion comprises a third linear portion, and
the second recessed portion comprises a fourth linear portion.

10. The cutting insert according to claim 9, wherein
at the fourth cross section,
an inclination angle of the fourth linear portion is greater than an inclination angle of the third linear portion, and
the fourth linear portion is shorter than the third linear portion.

11. A cutting tool comprising:
a holder having a rod shape extending from a first end toward a second end and comprising a pocket located at the first end; and
the cutting insert according to claim 1, the cutting insert being located in the pocket.

12. A method for manufacturing a machined product, the method comprising:
rotating a workpiece;
bringing the cutting tool according to claim 11 into contact with the workpiece being rotating; and
separating the cutting tool from the workpiece.
